(19) United States
(12) Patent Application Publication
(10) Pub. No.: US 2002/0146942 A1
(43) Pub. Date: Oct. 10, 2002

(54) Unlock proof squib connector

(76) Inventors: Patrick A. Bolen, Carthage, IL (US); Qiyuan Liu, Macomb, IL (US)

Correspondence Address: BLANK ROME COMISKY & MCCAULEY, LLP, 900 17TH STREET, N.W., SUITE 1000, WASHINGTON, DC, 20006, US

(21) Appl. No.: 09/828,057

(22) Filed: Apr. 9, 2001

(51) Int. Cl. H01R 13/415

(52) U.S. Cl. 439/743

(57) ABSTRACT

A squib connector is provided that allows detection of an improper connection within a squib connector prior to incorporation within an airbag mechanism. The squib connector includes a male squib connector and a female squib connector. Positioned within the female squib connector is a disengaging member. The disengaging member may be, for example, a spring or the like. The disengaging member prevents the male squib connector and female squib connector from having an electrical connection if the male squib connector and female squib connector are not properly interlocked. The disengaging member performs this function by forcing the male squib connector away from the female squib connector at such a distance that no electrical connection is possible. The improperly connected squib connector may then be more easily detected. Thus, the squib connector improves the efficiency and reliability of the airbag mechanism.

### BACKGROUND OF THE INVENTION

1. Field of the Invention

The present invention generally relates to an apparatus and a method that improves detection of a faulty connection within an airbag mechanism. More specifically, the present invention relates to a squib connector which allows a user to detect an improper connection between a male squib connector and a female squib connector.

2. Discussion of the Background

Airbag mechanisms in automobiles rely on a plurality of components for proper release of the airbag in emergency situations. Among these components are clocksprings and airbag igniters. Clocksprings and airbag igniters have an electrical connection by means of a squib connector.

A squib connector has a male squib connector and a female squib connector. The female squib connector is connected to an airbag canister. Typically, on an assembly line, the male squib connector is locked into a female squib connector by an operator who pushes the male squib connector into the female squib connector. Or, the male squib connector may be mechanically placed within the female squib connector. A defect in the squib connector can exist if the male squib connector has not been properly positioned within the female squib connector. However, there may be difficulty in locating the defect, based on the electrical connection that can still exist between the female squib connector and the male squib connector. The defective squib connector may still pass a test at the end of the assembly line for an electrical connection. However, the defect could eventually lead to airbag malfunction which may prove hazardous during emergency situations.

A need, therefore exists, to provide a squib connector with a mechanism to prevent faulty connections between the male squib connector and the female squib connector as the male squib connector and the female squib connector are interlocked on an assembly line. A further need exists to provide a more efficient and reliable airbag mechanism.

### SUMMARY OF THE INVENTION

The present invention provides a squib connector that prevents defects in coupling between a male squib connector and a female squib connector. A disengaging member implemented within the female portion prevents the male squib connector and the female squib connector from closing a circuit if the male squib connector and the female squib connector are not properly interlocked. Thus, the improper connection may be detected by a test at the end of an assembly line. The improved squib connector can be incorporated in an airbag mechanism to provide increased reliability and efficiency.

To this end, in an embodiment of the present invention, a squib connector is provided. The squib connector includes a male squib connector. A female squib connector sized to receive at least a portion of the male squib connector is also provided. The female squib connector includes a disengaging member located within the female squib connector.

In another embodiment of the present invention, a female squib connector is provided. The female squib connector has a disengaging member positioned within the female squib connector for providing resistance against the placement of at least a portion of a male squib connector within the female squib connector.

In still another embodiment of the present invention, a method is provided for detecting an improper connection in a circuit. The method includes the steps of providing a male squib connector; providing a female squib connector sized to receive at least a portion of the male squib connector; and positioning a disengaging member within the female squib connector for providing resistance against placement of the portion of the male squib connector within the female squib connector.

In yet another embodiment, an airbag mechanism is provided. The airbag mechanism includes a squib connector. The squib connector includes a female squib connector and a male squib connector. The squib connector further includes a disengaging member positioned within the female squib connector for providing resistance against placement of a portion of the male squib connector within the female squib connector until the female squib connector and the male squib connector are interlocked.

It is, therefore, an advantage of the present invention to provide an improved squib connector which prevents an improper connection of a male squib connector and a female squib connector.

Another advantage of the present invention is to provide an improved squib connector that increases detection of improperly connected squib connectors.

A further advantage of the present invention is to provide an improved squib connector that reduces the cost of manufacturing airbag mechanisms.

Yet another advantage of the present invention is to provide an improved squib connector that reduces costs of detecting improperly connected male and female squib connectors.

A still further advantage of the present invention is to provide an improved airbag mechanism having increased efficiency.

Another advantage of the present invention is to provide an improved airbag mechanism having increased reliability.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 illustrates a perspective view of an embodiment of a prior art squib connector;

FIG. 2 illustrates a perspective view of an embodiment of the present invention prior to assembly;

FIG. 3 illustrates a perspective view of an embodiment of the present invention prior to being in an interlocked state; and

FIG. 4 illustrates a perspective view of an embodiment of the present invention in an interlocked state.

### DETAILED DESCRIPTION OF THE PRESENTLY PREFERRED EMBODIMENTS

The present invention provides an improved squib connector implemented in an airbag mechanism that allows the user to detect a faulty connection between a male squib connector and a female squib connector. A disengaging member positioned within the female squib connector prevents an electrical connection between the male squib connector and the female squib connector until the male squib connector is interlocked with the female squib connector. If the male squib connector is not properly interlocked within the female squib connector, the faulty connection may be detected within the fault diagnostics of the vehicle airbag controller (i.e., an airbag annunciation light is illuminated). Thus, the improved squib connector increases the efficiency and reliability of the airbag mechanism.

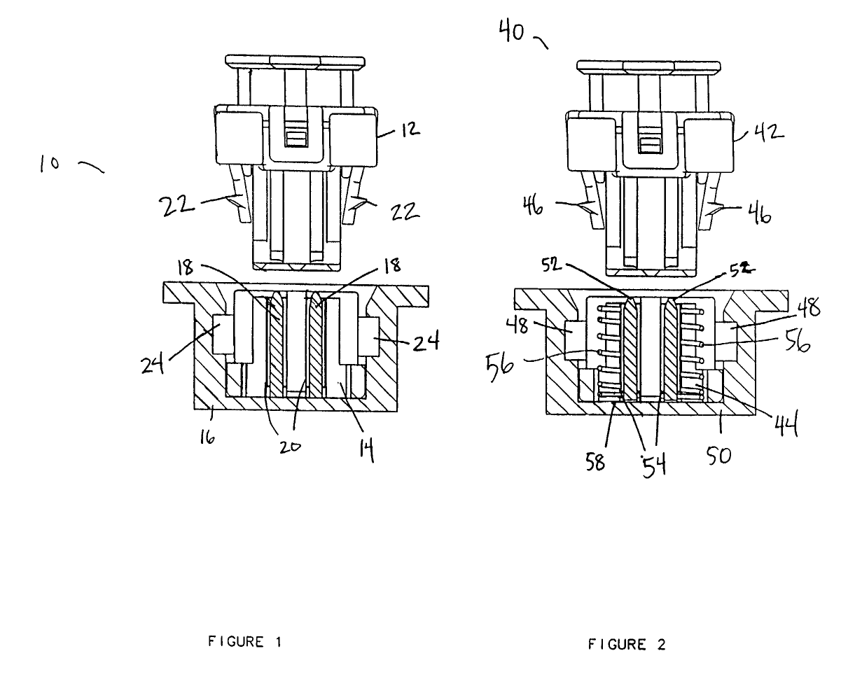

FIG. 1 illustrates an example of a prior art squib connector 10. The squib connector has a male squib connector 12 which is receivable within a female squib connector 14 which is located within a canister 16. Also located within the canister 16, and more specifically, within the female squib connector 14 are terminals 18 which provide an electrical connection with the male squib connector 12. A shorting bar 20 may also be present within the female squib connector 14 to provide an electrical connection with the male squib connector 12 when the male squib connector 12 is inserted within the female squib connector 14. The male squib connector 12 may be interlocked with the female squib connector 14, preferably, by positioning the ends 22 of the male squib connector 12 within edges 24 of the female squib connector 14. The ends 22 of the male squib connector 12 may provide resistance from removal from the female squib connector 14 once the ends 22 of the male squib connector 12 are positioned within the edges 24 of the female squib connector 14.

Once the male squib connector 12 is placed or positioned within close proximity to the terminals 18, an electrical connection may exist between the female squib connector 14 and the male squib connector 12. The male squib connector 12 need not be firmly secured within the female squib connector 14 for an electrical connection to exist between the male squib connector 12 and the female squib connector 14. In fact, when a user conducts a test at the end of the assembly line for a connection between the male squib connector 12 and a female squib connector 14, an electrically connected squib connector may pass this test. However, if the male squib connector 12 and the female squib connector 14 are not firmly interlocked, an airbag mechanism may not properly function.

FIG. 2 illustrates a squib connector 40, in a preferred embodiment of the present invention, prior to the positioning of a male squib connector 42 within a female squib connector 44. The female squib connector 44 is located within a canister 50. The male squib connector 42 and the female squib connector 44 may be constructed of any materials known to those skilled in the art. The male squib connector 42 has ends 46 which may be securely interlocked within edges 48 of the female squib connector 44. The ends 46 may be shaped as illustrated in FIG. 2. Further, the ends 46 may have any shape known to those skilled in the art which is capable of interlocking within the edges 48 of the female squib connector. The female squib connector 44 also contains terminals 52 and a shorting bar 54 for a potential electrical connection with the male squib connector 42. In addition, the female squib connector 44 contains a disengaging member 56 located on the outside of the terminals 52. The disengaging member 56 may be, for example, a spring or other compressible or elastic member. In addition, the disengaging member 56 may be constructed of any material known to those skilled in the art. Further, the disengaging member 56 may be attached to a base 58 of the female squib connector 44.

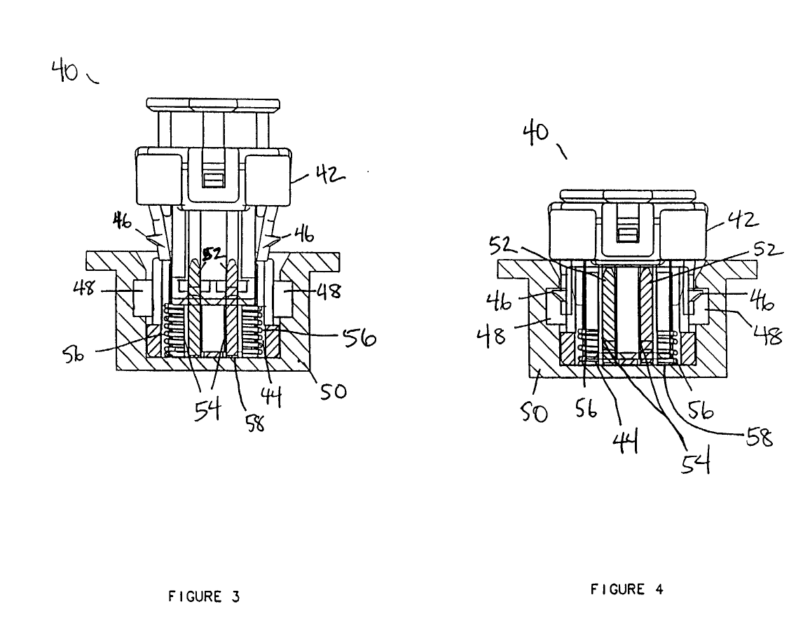

FIG. 3 illustrates the squib connector 40 where the male squib connector 42 has been positioned within the female squib connector 44. In the figure, the ends 46 of the male squib connector 42 are not positioned within the edges 48 of the female squib connector 44. Therefore, the male squib connector 42 is not securely interlocked with the female squib connector 44. The disengaging member 56 provides resistance against the male squib connector 42. The pressure exerted by the disengaging member 56 will prevent the male squib connector 42 and female squib connector 44 from obtaining an electrical connection until the male squib connector ends 46 are positioned securely within the edges 48 of the female squib connector 44. To this end, if the male squib connector 42 is not securely interlocked with the female squib connector 44, the disengaging member 56 will push the male squib connector 42 away from the female squib connector 44 such that no electrical connection can exist in the distance between the male squib connector 42 and the female squib connector 44.

FIG. 4 illustrates the squib connector 40 in which the male squib connector 42 is securely interlocked with the female squib connector 44. The ends 46 of the male squib connector 42 are positioned within the edges 48 of the female squib connector 44 to provide resistance from removal of the male squib connector 42 from the female squib connector 44. The force exerted by the disengaging member 56 against the male squib connector 42 cannot overcome the resistance by the male squib connector ends 46 against the edges 48 of the female squib connector 44. In this embodiment, a secure electrical connection can exist between the male squib connector 42 and the female squib connector 44 because the disengaging member 56 cannot force the male squib connector 42 away from the female squib connector 44 at such a distance that an electrical connection is impossible. Thus, the male squib connector 42 is both interlocked and electrically connected within the female squib connector 44. The resulting squib connector 40 should then, theoretically, pass a test for a proper connection at the end of the assembly line.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that all such changes and modifications be covered by the appended claims.

1. A squib connector comprising:
a male squib connector;
a female squib connector sized to receive at least a portion of the male squib connector; and
a disengaging member positioned within the female squib connector.

2. The squib connector of claim 1 wherein the disengaging member is compressible.

3. The squib connector of claim 1 wherein the disengaging member is a spring.

4. The squib connector of claim 1 wherein the disengaging member is attached to a base of the female squib connector.

5. The squib connector of claim 1 wherein the male squib connector has a set of ends and further wherein the female squib connector has a set of edges capable of receiving said set of ends.

6. The squib connector of claim 5 wherein the disengaging member forces the male squib connector away from the female squib connector until said set of ends are positioned within said set of edges.

7. A female squib connector sized to receive at least a portion of a male squib connector, the female squib connector having a compressible member positioned within the female squib connector for providing resistance against placement of the portion of the male squib connector within the female squib connector.

8. The female squib connector of claim 7 wherein the compressible member is a spring.

9. The female squib connector of claim 7 including a set of edges sized to receive a set of ends of the male squib connector, whereby the compressible member prevents placement of the portion of the male squib connector within the female squib connector until the set of ends are positioned within the set of edges.

10. The female squib connector of claim 7 wherein the compressible member prevents an electrical connection between the female squib connector and the male squib connector until the female squib connector and male squib connector are interlocked.

11. A method for detecting an improper connection in a circuit, the method comprising the steps of:
providing a male squib connector;
providing a female squib connector sized to receive at least a portion of the male squib connector; and
positioning an elastic member within the female squib connector for providing resistance against placement of the portion of the male squib connector within the female squib connector.

12. The method of claim 11 wherein the elastic member provides resistance against placement of the portion of the male squib connector within the female squib connector until the male squib connector and the female squib connector are interlocked.

13. The method of claim 11 further comprising attaching the elastic member to a base of the female squib connector.

14. The method of claim 11 further comprising preventing an electrical connection between the female squib connector and the male squib connector until the female squib connector and male squib connector are interlocked.

15. The method of claim 11 further comprising conducting a test for an electrical connection between the male squib connector and the female squib connector.

16. An airbag mechanism including a squib connector having a female squib connector and a male squib connector and further having a disengaging member positioned within the female squib connector for providing resistance against placement of a portion of the male squib connector within the female squib connector until the female squib connector and male squib connector are interlocked.

17. An airbag mechanism of claim 16 wherein the disengaging member prevents an electrical connection between the female squib connector and the male squib connector until the female squib connector and male squib connector are interlocked.

18. The airbag mechanism of claim 16 wherein the disengaging member is compressible.

19. The airbag mechanism of claim 16 wherein the disengaging member is elastic.

20. The airbag mechanism of claim 16 wherein the disengaging member is a spring attached to a base of the female squib connector.
